(19) United States
(12) Patent Application Publication
(10) Pub. No.: US 2016/0061134 A1
(43) Pub. Date: Mar. 3, 2016

(54) METHOD AND SYSTEM FOR OPERATING AN ENGINE

(71) Applicant: Caterpillar Inc., Peoria, IL (US)

(72) Inventors: Matthew P. Fletcher, Lafayatte, IN (US); Adwait V. Joshi, Dunlap, IL (US); Matthew Mowers, Peoria, IL (US); Brandon Abel, Peoria, IL (US); Deepti Bhosekar, Dunlap, IL (US); Karthik Jayasankaran, Peoria, IL (US)

(73) Assignee: Caterpillar Inc., Peoria, IL (US)

(21) Appl. No.: 14/469,618

(22) Filed: Aug. 27, 2014

(51) Int. Cl. F02D 41/14; F01N 3/18; F02D 41/02

(52) U.S. Cl. CPC F02D 41/1446; F02D 41/0275; F01N 3/18

(57) ABSTRACT

An engine control system including an engine configured to generate exhaust comprising an exhaust constituent and to operate in a first operating mode or a second operating mode different from the first operating mode. The engine control system can include a plurality of sensors configured to generate temperature data corresponding to at least one of a measured exhaust temperature and an ambient temperature, and exhaust constituent data corresponding to an exhaust constituent concentration. The engine control system can include a controller operatively coupled to the plurality of sensors and the engine, and configured to receive the temperature data and the exhaust constituent data from the plurality of sensors, and change an operating state of the engine from the first operating mode to the second operating mode when the temperature data is less than a predetermined temperature threshold and the exhaust constituent data is greater than a predetermined exhaust constituent threshold.

### TECHNICAL FIELD

The present disclosure relates generally to a method and system for operating an engine, and more specifically to a method and system for operating an engine to reduce an exhaust constituent concentration in an exhaust flow from the engine.

### BACKGROUND

Internal combustion engines, such as diesel engines, spark ignition engines, gas turbine engines, and the like, are known for converting chemical energy stored in a fuel into mechanical shaft power through combustion of the fuel with an oxidizer. The combustion process generates an exhaust stream, which may be emitted from the engine. The exhaust stream may include various exhaust constituents, including, but not limited to, carbon dioxide, carbon monoxide, hydrocarbons, water, nitrogen, oxides of nitrogen (NOx), and particulate matter. Government regulations limit emissions of some exhaust constituents, thereby motivating manufacturers and operators of engines to control concentrations of the regulated exhaust constituents. Exhaust emissions may be controlled through control of the combustion process, operation of exhaust aftertreatment devices downstream of the combustion process, or combinations thereof. Further, the control of an exhaust constituent concentration can be accomplished in conjunction with sensing and control of an operating temperature of the engine.

For example, U.S. Patent Publication No. 2014/0102080 filed on Dec. 26, 2013, and entitled “NH₃ EMISSIONS MANAGEMENT IN A NOx REDUCTION SYSTEM” (“the '080 publication”), purports to describe control of NOx reduction systems to minimize the amount of slip of NH₃ from the system. The '080 publication recognizes that urea may accumulate in the exhaust by operating the engine with urea injection when exhaust temperatures are too low to support evaporation and hydrolysis of the injected urea. In turn, a controller of the '080 publication includes a urea deposit module that determines a urea deposit amount in response to an exhaust temperature value, an ambient temperature value, and a urea injection amount; and a deposit clearing module that initiates a desoot regeneration event in response to the urea deposit amount. The desoot regeneration event of the '080 publication simultaneously increases the exhaust temperature above a urea decomposition temperature and increases NOx emissions.

However, the control actions taken by the '080 publication to control ammonia slip from an exhaust aftertreatment system may have disadvantageous effects on concentrations of other exhaust constituents. Accordingly, the system and method of the present disclosure solves one or more problems set forth above and/or other problems in the art.

### SUMMARY

According to an aspect of the disclosure, an engine control system includes an engine, a plurality of sensors, and a controller operatively coupled to the plurality of sensors and the engine. The engine is configured to generate exhaust comprising an exhaust constituent and to operate in a first operating mode or a second operating mode different from the first operating mode. An exhaust temperature during the second operating mode is higher than an exhaust temperature during the first operating mode, and an exhaust constituent concentration during the second operating mode is lower than an exhaust constituent concentration during the first operating mode. The plurality of sensors is configured to generate temperature data corresponding to at least one of a measured exhaust temperature and an ambient temperature, and exhaust constituent data corresponding to an exhaust constituent concentration. The controller is configured to receive the temperature data and the exhaust constituent data from the plurality of sensors, and change an operating state of the engine from the first operating mode to the second operating mode when the temperature data is less than a predetermined temperature threshold and the exhaust constituent data is greater than a predetermined exhaust constituent threshold.

According to another aspect of the disclosure, a method for operating an engine includes receiving temperature data and exhaust constituent data from a plurality of sensors, and changing an operating state of the engine from a first operating mode to a second operating mode when the temperature data is less than a predetermined temperature threshold and the exhaust constituent data is greater than a predetermined exhaust constituent threshold. The temperature data corresponds to at least one of a measured exhaust temperature of an engine and an ambient temperature, and the exhaust constituent data corresponds to an exhaust constituent concentration of the engine. An exhaust temperature during the second operating mode is higher than an exhaust temperature during the first operating mode, and an exhaust constituent concentration during the second operating mode is lower than an exhaust constituent concentration during the first operating mode.

In another aspect, the present disclosure is directed to a non-transitory machine-readable medium comprising code embodied on the non-transitory machine-readable medium, which when executed, causes a controller to operate an engine in a machine by receiving temperature data and exhaust constituent data from a plurality of sensors, and changing an operating state of the engine from a first operating mode to a second operating mode when the temperature data is less than a predetermined temperature threshold and the exhaust constituent data is greater than a predetermined exhaust constituent threshold. The temperature data corresponds to at least one of a measured exhaust temperature of an engine and an ambient temperature, and the exhaust constituent data corresponds to an exhaust constituent concentration of the engine. An exhaust temperature during the second operating mode is higher than an exhaust temperature during the first operating mode, and an exhaust constituent concentration during the second operating mode is lower than an exhaust constituent concentration during the first operating mode.

### BRIEF DESCRIPTION OF THE DRAWINGS

FIG. 1 depicts a machine, according to an aspect of the disclosure;

FIG. 2 is a box diagram of a machine, according to an aspect of the disclosure;

FIG. 3 is a box diagram of a controller, according to an aspect of the disclosure;

FIG. 4 depicts a process for operating a machine, according to an aspect of the disclosure;

FIG. 5 depicts a partial process for operating a machine, according to an aspect of the disclosure;

FIG. 6 depicts a process for operating an engine in a second operating mode, according to an aspect of the disclosure; and

FIG. 7 depicts a partial process for operating a machine, according to an aspect of the disclosure.

### DETAILED DESCRIPTION

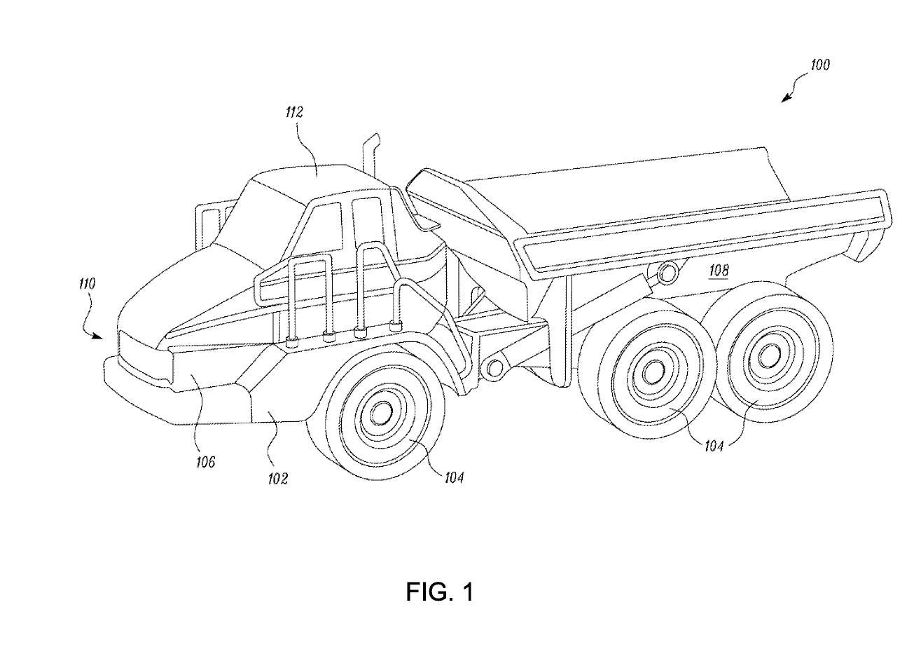

FIG. 1 depicts a machine 100. In one aspect, the machine 100 may embody an articulated truck. Alternatively, the machine 100 may include a track-type tractor, a hydraulic excavator, a wheel loader, a haul truck, a large mining truck, an off-highway truck, locomotives, machines for rail applications, and the like. It should be understood that the machine 100 may embody any machine associated with mining, agriculture, forestry, construction, transportation, as well as other industrial applications known in the art.

As illustrated in FIG. 1, the machine 100 may be a wheeled machine and includes a frame 102, wheels 104, an engine compartment 106, and a payload carrier 108. The machine 100 may further include an engine positioned in the engine compartment 106 and supported on the frame 102. The engine may be an internal combustion engine such as, for example, a reciprocating piston engine or a gas turbine engine. According to an aspect of the disclosure, the engine may be a compression ignition engine, such as, a diesel engine, a homogeneous charge compression ignition engine, a reactivity controlled compression ignition engine, or other compression ignition engine known in the art. According to another aspect of the disclosure, the engine may comprise a spark ignition engine. The engine may be fueled by distillate diesel, biodiesel, dimethyl ether, alcohol, gasoline, natural gas, propane, hydrogen, combinations thereof, or any other combustion fuel known in the art.

In the illustrated aspect, a cab 112 is mounted on a front end 110 of the frame 102 of the machine 100. The cab 112 is disposed above the engine and extends rearward beyond the engine. In some aspects, the cab 112 may enclose the engine by forming a portion of the engine compartment 106. The cab 112 may include a suitable station for a machine operator, and may house various controls, displays, and interface equipment for machine operation.

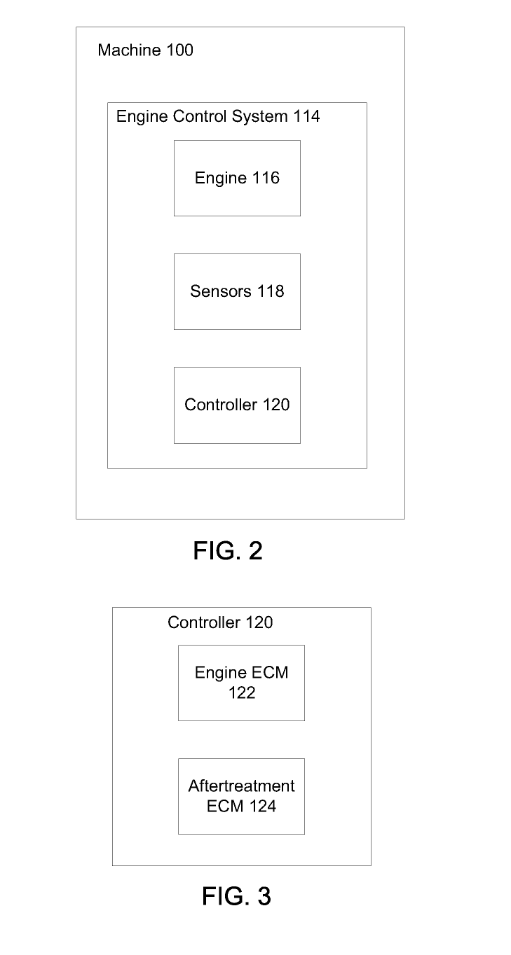

As shown in FIG. 2, the machine 100 can also comprise an engine control system 114. The engine control system 114 can comprise an engine 116, sensors 118, and a controller 120. For the examples provided below, the engine 116 comprises a diesel engine and utilizes diesel fuel. However, as noted above, the engine 116 may comprise other types of engines.

The engine 116 can be configured to generate exhaust comprising an exhaust constituent. In an aspect, the exhaust constituent comprises nitrogen oxides (“NOx”). However, the exhaust constituent can also comprise other types of emissions. The engine 116 can operate in a first operating mode or a second operating mode. The first operating mode can be, for example, a normal operating mode of the engine 116. However, in the second operating mode, exhaust temperature can be increased, while the exhaust constituent concentration can be reduced. For example, an exhaust temperature during the second operating mode can be higher than an exhaust temperature during the first operating mode. Furthermore, an exhaust constituent concentration during the second operating mode can be lower than an exhaust constituent concentration during the first operating mode.

In an aspect, the sensors 118 can comprise actual or virtual sensors. The sensors 118 can also be located in various portions of the machine 100. In an aspect, the sensors 118 can comprise at least a temperature sensor and an exhaust constituent sensor. The temperature sensor can generate, for example, temperature data corresponding to at least one of a measured exhaust temperature and an ambient temperature. The exhaust constituent sensor can generate exhaust constituent data corresponding to an exhaust constituent concentration. Although the temperature sensor and the exhaust constituent sensor are disclosed above, the sensors 118 can comprise additional or other types of sensors known to persons having skill in the art.

Referring to FIG. 3, the controller 120 can also comprise one or more engine control modules (“ECMs”). In FIG. 3, the controller 120 comprises an engine ECM 122 and an aftertreatment ECM 124. However, the controller 120 may comprise more or less ECMs. For example, in some machines, the controller 120 may comprise up to 8 ECMs. Furthermore, the controller 120 may comprise other types of ECMs and are not restricted to just the ECMs disclosed above. The controller 120 can activate or deactivate the second operating mode for the engine 116. That is, the controller 120 can change an operating state of the engine 116 from the first operating mode to the second operating mode.

In an aspect, the controller 120 can receive the temperature data and the exhaust constituent data from the sensors 118. Furthermore, the controller 120 can change an operating state of the engine 116 from the first operating mode to the second operating mode when the temperature data is less than a predetermined temperature threshold and the exhaust constituent data is greater than a predetermined exhaust constituent threshold. In an aspect, when the engine 116 operates in the second operating mode, a temperature of the engine 116 can be increased, while a NOx emissions of the engine 116 can be decreased.

### INDUSTRIAL APPLICABILITY

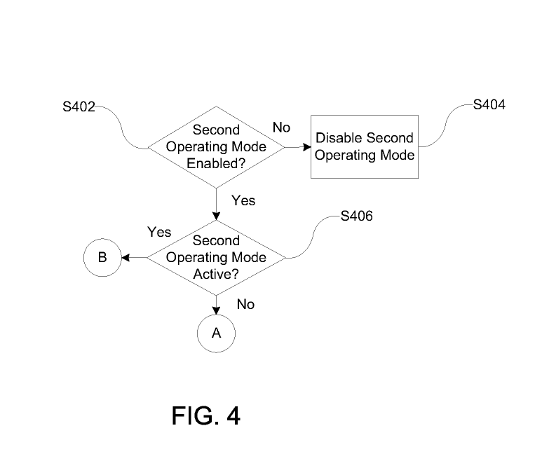

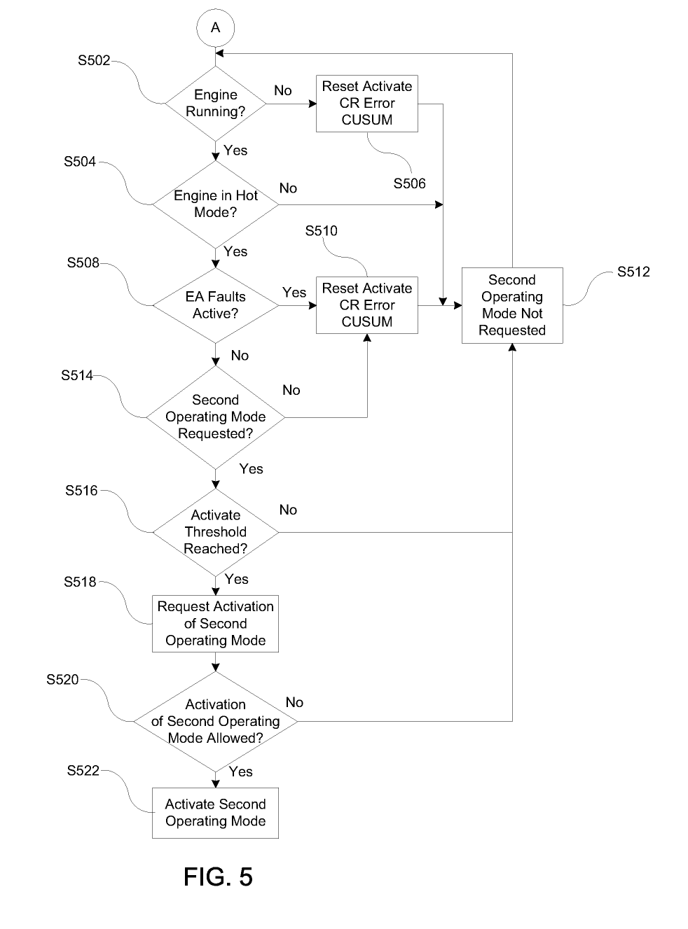

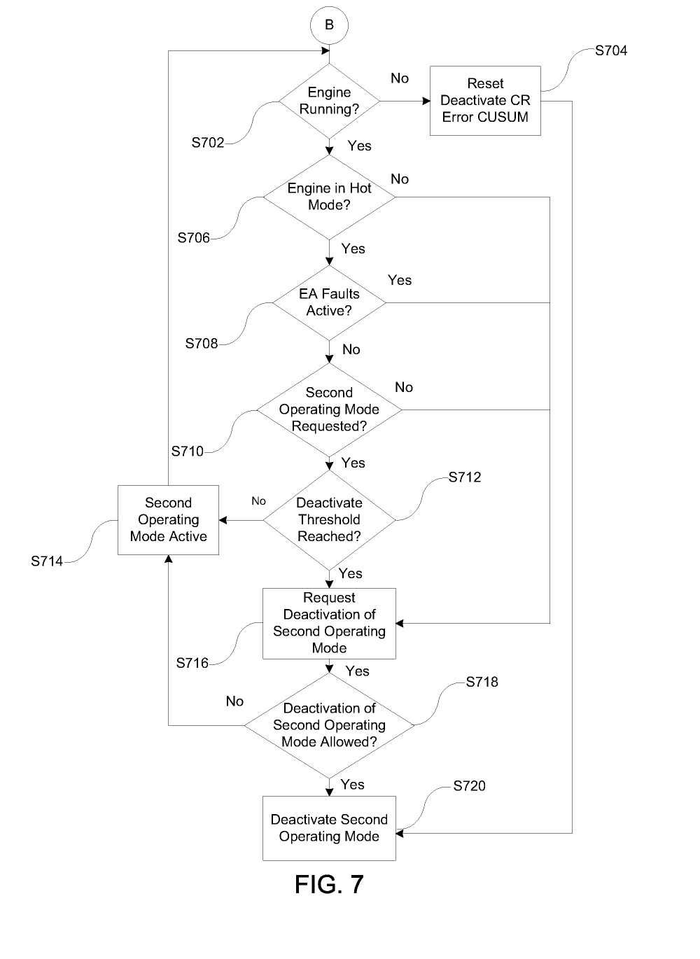

In an aspect, a method for operating the engine 116 is shown in FIGS. 4-7. In FIG. 4, the controller 120 determines if the second operating mode is enabled in block 5402. For example, in some machines the second operating mode should not be utilized, even if it is available. This can occur, for example, due to various reasons such as owner preference, machine requirements, or other business reasons. Thus, the second operating mode may be enabled or disabled based on whether the second operating mode should be utilized. If the second operating mode should not be enabled, then the controller 120 disables the second operating mode in block 5404. In block 5406, the controller 120 determines if the second operating mode is active in the engine 116. If the second operating mode is inactive, then the controller 120 proceeds to additional blocks shown in FIG. 5. Otherwise, the second operating mode is active, then the controller 120 proceeds to additional blocks shown in FIG. 7.

Referring to FIG. 5, in block S502 the controller 120 determines if the engine 116 is running. If the engine is not running, then in block S506, the controller 120 resets the Activate Conversion Ratio (“CR”) Error Cumulative Sum (“CUSUM”) variable. The Activate CR Error indicates a conversion ratio error through an emissions aftertreatment system. The Activate CR Error Cumulative Sum is a sum of the Activate CR Errors, which will be described in more detail below. Then, in block 5512, the controller 120 does not request the second operating mode and the process returns to block S502.

However, if the controller 120 determines that the engine 116 is running in block S502, then in block 5504, the controller 120 determines if the engine 116 is in hot mode. In an aspect, the determination of whether the engine 116 is in hot mode or not can be based on a temperature of the engine 116. In an aspect, the temperature of the engine 116 can be determined based on a temperature of the coolant, or other temperature indicative of engine temperature known in the art. In an aspect, when the engine 116 is in the hot mode, the engine 116 is warmed up and the engine 116 is running in an intended emissions control map. If the engine 116 is not in hot mode, then the controller 120 proceeds to block 5512. That is, if the engine 116 is not above a predetermined temperature threshold as indicated by the temperature of the engine 116, then the engine 116 is not in the hot mode.

Otherwise, if the engine 116 is in hot mode, then in block 5508, the controller 120 receives an aftertreatment fault signal and determines whether the exhaust aftertreatment faults are active. The exhaust aftertreatment fault signal indicating whether the exhaust aftertreatment faults are active or not can be generated by the aftertreatment ECM 124. The exhaust aftertreatment faults can indicate errors or issues with an aftertreatment process. If the exhaust aftertreatment fault signals indicate that the aftertreatment faults are active (i.e., there are exhaust aftertreatment faults), then the engine 116 should not be operating in the second operating mode. Thus, in block 5510 the controller 120 resets the Activate CR Error CUSUM, similar to block S506, and proceeds to block 5512.

Otherwise, if the exhaust aftertreatment signal indicates that the exhaust aftertreatment faults are not active (i.e., there is an absence of exhaust aftertreatment faults), then in block 5514 the controller 120 determines if the second operating mode has been requested. The second operating mode can be requested, for example, by one or more of the ECMs in the controller 120, such as the aftertreatment ECM 124, or other electronic devices within the machine 100. For example, the controller 120 can request the second operating mode based on the temperature data from the sensors 118. In an aspect, the controller 120 can also request the second operating mode based on ambient pressure data of the engine 116 from the sensors 118. In addition, the controller 120 can also request the second operating mode based on additional data from the sensors 118.

In an aspect, the temperature data can correspond to ambient temperature, measured exhaust temperature of the engine 116, or any combination thereof. Furthermore, the controller 120 can also utilize a map in addition to the temperature data to determine whether or not to request the second operating mode. For example, when the temperature data is less than a predetermined temperature threshold, the controller 120 can request that the engine 116 operate in the second operating mode. If the second operating mode has not been requested, then the controller 120 proceeds to block 5512, and does not request the second operating mode.

In block 5516, the controller 120 determines whether the threshold to activate the second operating mode has been reached. Thus, the controller 120 can determine whether the Activate CR Error CUSUM is greater than a predetermined Activate CR Error CUSUM threshold. As previously noted, the Activate CR Error CUSUM corresponds to the exhaust constituent threshold. Thus, when the Activate CR Error CUSUM is greater than a predetermined Activate CR Error CUSUM threshold, this provides an indication that the exhaust constituent data is greater than a predetermined exhaust constituent threshold, and that the threshold to activate the second operating mode has been reached.

If the controller 120 determines that the threshold to activate the second operating mode has not been reached, then the controller 120 proceeds to block 5512 and does not request the second operating mode. Otherwise, in block 5518, the controller 120 requests that the second operating mode be activated. In block 5520, the controller 120 determines whether the activation of the second operating mode is allowed. For example, the activation of the second operating mode may be allowed based on engine operating conditions for the engine 116. Thus, the controller 120 may receive fuel data or engine speed data from the engine 116 and the activation of the second operating mode may be allowed when certain fuel or engine speed conditions for the engine 116 are met. Otherwise, the activation of the second operating mode may not be allowed.

If the activation of the second operating mode is not allowed, then the controller 120 proceeds to block 5512 and does not request the second operating mode. If the activation of the second operating mode is allowed, then the controller 120 proceeds to block 5522 and activates the second operating mode for the engine 116. When the controller 120 activates the second operating mode, the controller 120 can transition the engine 116 from the first operating mode to the second operating mode.

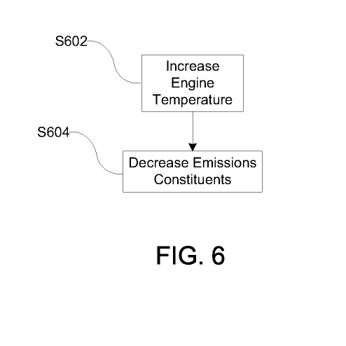

Furthermore, as shown in FIG. 6, a process for operating the engine 116 in the second operating mode is shown. In block S602, the engine temperature of the engine 116 is increased. The engine temperature can comprise exhaust temperature or an ambient temperature. Thus, increasing the engine temperature can be detected through an increase in the temperature data, which corresponds to at least one of the measured exhaust temperature or the ambient temperature. In block S604, the emissions constituents of the engine 116 are decreased. For example, an ignition timing of the engine 116 during the second operating mode is later than the ignition timing of the engine 116 during the first operating mode. The delay in the ignition timing can simultaneously decrease the emissions constituents of the engine 116 and increase exhaust temperature. In another aspect, a conventional single shot can be split into multiple smaller shots in one piston cycle. Relative quantities and timings of each shot can be adjusted to simultaneously decrease the emissions constituents of the engine 116 and increase exhaust temperature. A shot can be, for example, a fuel injection event. In an aspect, the multiple shots can comprise one or more of a pilot injection, a main injection, a post injection, and any combination thereof. Furthermore, in an aspect, a fuel rail pressure can also be modified to simultaneously decrease the emissions constituents of the engine 116 and increase exhaust temperature.

Thus, when the temperatures is less than a predetermined temperatures threshold, and the exhaust constituent data is greater than a predetermined exhaust constituent threshold, the controller 120 can change an operating state of the engine 116 from the first operating mode to the second operating mode.

FIG. 7 depicts additional blocks as a continuation of those shown in FIG. 4. In block S702, the controller 120 determines if the engine 116 is running. If the engine 116 is not running, then the controller 120 proceeds to block S704 where the controller 120 resets a Deactviate CR Error CUSUM. The Deactivate CR Error CUSUM can correspond to an ability of the engine 116 to meet a desired conversion ratio error through an emissions aftertreatment system. Thus, in an aspect, the Deactivate CR Error CUSUM can have an inverse relationship with the exhaust constituent concentration. That is, a higher Deactivate CR Error CUSUM can correspond with a lower exhaust constituent concentration, while a lower Deactivate CR Error CUSUM can correspond with a higher exhaust constituent concentration.

Otherwise, if the engine 116 is running in block S702, then the controller 120 in block 5706 determines if the engine 116 is in the hot mode. If the engine 116 is not in the hot mode, then the controller 120 proceeds to block 5716, and requests deactivation of the second operating mode. If the engine 116 is in the hot mode, then the controller 120 determines in block S708 whether the exhaust aftertreatment faults are active or not. If the exhaust aftertreatment faults are active, then the controller 120 proceeds to block 5716. Otherwise, if the exhaust aftertreatment faults are not active, then in block 5710, the controller 120 determines if the second operating mode was requested. As previously noted, the second operating mode can be requested by any of the ECMs in the controller 120 or other electronic device in the machine 100.

If the second operating mode was not requested, then the controller 120 proceeds to block 5716. Otherwise, in block 5712, the controller 120 determines if the deactivate threshold has been reached. That is, if the Deactivate CR Error CUSUM is greater than a Deactivate CR Error CUSUM threshold, then the deactivate threshold has been reached. If the deactivate threshold has not been reached, then in block 5714, the controller 120 maintains the second operating mode as active and maintains the operating state of the engine 116 in the second operating mode.

Otherwise, as previously noted, in block 5716, the controller 120 requests deactivation of the second operating mode. In block 5718, the controller 120 determines whether deactivation of the second operating mode is allowed. Whether the deactivation of the second operating mode is allowed or not can also be based on the engine operating conditions for the engine 116. If the deactivation of the second operating mode is not allowed, then the controller 120 proceeds to block 5714. Otherwise, in block 5720, the controller 120 deactivates the second operating mode. The controller 120 can then change the operating of the engine 116 from the second operating mode to the first operating mode.

It will be apparent to those skilled in the art that various modifications and variations can be made to the disclosed system and method. Other aspects will be apparent to those skilled in the art from consideration of the specification and practice of the disclosed system and method. It is intended that the specification and examples be considered as exemplary only, with a true scope being indicated by the following claims.

What is claimed is:

1. An engine control system comprising:
an engine configured to generate exhaust comprising an exhaust constituent and to operate in a first operating mode or a second operating mode different from the first operating mode, an exhaust temperature during the second operating mode being higher than an exhaust temperature during the first operating mode, an exhaust constituent concentration during the second operating mode being lower than an exhaust constituent concentration during the first operating mode;
a plurality of sensors configured to generate:
temperature data corresponding to at least one of a measured exhaust temperature and an ambient temperature, and
exhaust constituent data corresponding to an exhaust constituent concentration; and
a controller operatively coupled to the plurality of sensors and the engine, the controller configured to:
receive the temperature data and the exhaust constituent data from the plurality of sensors, and
change an operating state of the engine from the first operating mode to the second operating mode when the temperature data is less than a predetermined temperature threshold and the exhaust constituent data is greater than a predetermined exhaust constituent threshold.

2. The engine control system of claim 1 wherein the exhaust constituent comprises nitrogen oxides (NOx).

3. The engine control system of claim 1 wherein the controller is further configured to receive an exhaust aftertreatment fault signal, and operate the engine in the second operating mode only when the exhaust aftertreatment fault signal indicates an absence of exhaust aftertreatment faults.

4. The engine control system of claim 3 wherein the controller is further configured to change the operating state of the engine from the second operating mode to the first operating mode when the exhaust aftertreatment fault signal indicates an exhaust aftertreatment fault.

5. The engine control system of claim 1 wherein the controller is further configured to receive engine speed data from the engine, and to operate the engine in the second operating mode based in part on the engine speed data of the engine.

6. The engine control system of claim 1 wherein the controller is further configured to receive ambient pressure data from the engine, and to operate the engine in the second operating mode based in part on the ambient pressure data of the engine.

7. The engine control system of claim 1 wherein an ignition timing of the engine during the second operating mode is later than the ignition timing of the engine during the first operating mode.

8. The engine control system of claim 1 wherein the engine comprises a diesel engine.

9. The engine control system of claim 1 wherein the controller comprises at least one of an aftertreatment engine control module (ECM) and an engine ECM.

10. A method for operating an engine comprising:
receiving temperature data and exhaust constituent data from a plurality of sensors,
wherein the temperature data corresponds to at least one of a measured exhaust temperature of an engine and an ambient temperature, and
wherein the exhaust constituent data corresponds to an exhaust constituent concentration of the engine; and
changing an operating state of the engine from a first operating mode to a second operating mode when the temperature data is less than a predetermined temperature threshold and the exhaust constituent data is greater than a predetermined exhaust constituent threshold,
wherein an exhaust temperature during the second operating mode is higher than an exhaust temperature during the first operating mode, and an exhaust constituent concentration during the second operating mode is lower than an exhaust constituent concentration during the first operating mode.

11. The method of claim 10 wherein the exhaust constituent comprises nitrogen oxides (NOx).

12. The method of claim 10 further comprising:
receiving an exhaust aftertreatment fault signal; and
operating the engine in the second operating mode only when the exhaust aftertreatment fault signal indicates an absence of exhaust aftertreatment faults.

13. The method of claim 12 further comprising:
changing the operating state of the engine from the second operating mode to the first operating mode when the exhaust aftertreatment fault signal indicates an exhaust aftertreatment fault.

14. The method of claim 10 further comprising:
receiving engine speed data from the engine; and
operating the engine in the second operating mode based in part on the engine speed data of the engine.

15. The method of claim 10 further comprising:
receiving ambient pressure data from the engine; and
operating the engine in the second operating mode based in part on the ambient pressure data of the engine.

16. The method of claim 10 wherein an ignition timing of the engine during the second operating mode is later than the ignition timing of the engine during the first operating mode.

17. The method of claim 10 wherein the engine comprises a diesel engine.

18. A non-transitory machine-readable medium comprising code embodied on the non-transitory machine-readable medium, which when executed, causes a controller to operate an engine in a machine by:
receiving temperature data and exhaust constituent data from a plurality of sensors,
wherein the temperature data corresponds to at least one of a measured exhaust temperature of an engine and an ambient temperature, and
wherein the exhaust constituent data corresponds to an exhaust constituent concentration of the engine; and
changing an operating state of the engine from a first operating mode to a second operating mode when the temperature data is less than a predetermined temperature threshold and the exhaust constituent data is greater than a predetermined exhaust constituent threshold,
wherein an exhaust temperature during the second operating mode is higher than an exhaust temperature during the first operating mode, and an exhaust constituent concentration during the second operating mode is lower than an exhaust constituent concentration during the first operating mode.

19. The non-transitory machine-readable medium of claim 18 wherein the exhaust constituent comprises nitrogen oxides (NOx), the engine comprises a diesel engine, and an ignition timing of the engine during the second operating mode is later than the ignition timing of the engine during the first operating mode.

20. The non-transitory machine-readable medium of claim 19 wherein the controller is further configured to operate an engine in a machine by:
receiving an exhaust aftertreatment fault signal;
operating the engine in the second operating mode only when the exhaust aftertreatment fault signal indicates an absence of exhaust aftertreatment faults; and
changing the operating state of the engine from the second operating mode to the first operating mode when the exhaust aftertreatment fault signal indicates an exhaust aftertreatment fault.
